(19) United States
(12) Patent Application Publication
(10) Pub. No.: US 2002/0176449 A1
(43) Pub. Date: Nov. 28, 2002

(54) HDLC (high-level data link control) frames

(76) Inventor: Daniel Trippe, Sudbury, MA (US)

Correspondence Address: FOLEY HOAG LLP, PATENT GROUP, WORLD TRADE CENTER WEST, 155 SEAPORT BOULEVARD, BOSTON, MA, 02110-2600, US

(21) Appl. No.: 10/094,915

(22) Filed: Mar. 11, 2002

Related U.S. Application Data
(60) Provisional application No. 60/293,050, filed on May 23, 2001.

(51) Int. Cl. H04J 3/02; H04J 3/07

(52) U.S. Cl. 370/505; 370/537

(57) ABSTRACT

The disclosure describes generation of HDLC (High-Level Data Link Control) frame bits by the application of an HDLC stuffing operation that operates on bits in parallel. The disclosure also describes parallel bit processing for destuffing bits of an HDLC (High-Level Data Link Control) frame.

### REFERENCE TO RELATED APPLICATION

This application claims priority to co-pending U.S. Provisional Application Ser. No. 60/293,050, filed on May 23, 2001, entitled “Bit-oriented HDLC Framer with Parallel Processing”.

### BACKGROUND

Computer networks enable computing devices to exchange information. Most networks support this communication by carrying bits (i.e., signals representing a “1” or a “0”) between devices. These bits can represent anything from a webpage picture to a bank account balance. Sometimes, however, errors occur. For example, sometimes a network loses a bit, mistakes a “1” for a “0”, and so forth.

To provide more reliable communication, many computers send a stream of bits within a collection of “frames” where individual frames carry a portion of the bit stream. Frames can also include information that a frame receiver can use to detect and even repair transmission errors.

To illustrate framing, FIG. 1 depicts a series of bits 102 that one computer wants to send to another. As shown, a frame 114 carries some portion 108 of the original bit stream 102. More specifically, the frame 114 shown is an HDLC (High-Level Data Link Control) frame. An HDLC frame 114 includes at least one frame flag 104 that identifies the frame boundary. The frame flag 104 is a pre-defined sequence of eight-bits: “01111110”. Thus, a receiver that detects this bit pattern in a series of received bits knows that it has encountered a frame boundary.

Since frames 114 can carry arbitrary sequence of bits, the possibility arises that some part of the original bit stream 102 may happen to include the same string of bits pre-defined as a frame flag. For example, in FIG. 1, the original bit stream 102 features bits, “01111110”, that are coincidentally the same as the frame flag bits. To prevent these bits from falsely signifying a frame boundary to a receiver, HDLC uses a technique known as “zero stuffing”. Zero stuffing causes insertion of a “0” bit 112 after a string of five consecutive “1” bits. Thus, as shown, bits of bit stream 102 are stored in the frame as “011111011” 108 instead of “01111110”. After stuffing, bits within a frame will not trick a receiver into erroneously identifying a frame boundary. A receiver of these bits 114 can recover the original bit sequence 102 by “destuffing” bits (removing “0” bits following five consecutive “1”-s) within a received HDLC frame.

### SUMMARY

In general, in one aspect, the disclosure features a method of generating bits of an HDLC (High-Level Data Link Control) frame. The method includes receiving a group of bits and determining HDLC frame bits by applying an HDLC stuffing operation to more than one of the bits in parallel.

Embodiments may include one or more of the following features. The more than one bits may be 2ⁿ bits, where n>0. Applying the HDLC stuffing operation may occur in a single clock cycle. Applying the HDLC stuffing operation may include applying combinatorial logic on the more than one bits, for example, via logic implemented on a FPGA (Field Programmable Gate Array). Applying the HDLC stuffing operation may include identifying a number of trailing “1”-s in a previous group of bits. The method may further include receiving HDLC control signals (e.g., start-of-frame, end-of-frame, and abort) and outputting corresponding HDLC bit sequences. The method may further include determining an HDLC checksum.

The method may further include receiving bits from different logical channels, storing a context for the different logical channels that includes information used in the HDLC stuffing operation, and accessing the context for a one of the logical channels providing the more than one bits. At least one of the logical channels may correspond to one of the following: a DS0 signal, a DS1 signal, a fractional DS1 signal, and a clear-channel DS3 signal.

In general, in another aspect, the disclosure features a method of processing bits of an HDLC (High-Level Data Link Control) frame. The method includes receiving bits of the HDLC frame and applying an HDLC destuffing operation to more than one of the bits in parallel.

Embodiments may include one or more of the following features. The more than one bits may be 2ⁿ bits, where n>0. Applying the HDLC destuffing operation may occur in a single clock cycle. Applying the HDLC destuffing operation may include applying combinatorial logic on the more than one bits, for example, via logic implemented on a FPGA (Field Programmable Gate Array). Applying the HDLC destuffing operation may include identifying a number of trailing “1”-s in a previous group of bits.

The method may further include receiving bits from different logical channels, storing a context for the different logical channels that includes information used in the destuffing operation, and accessing the context for a one of the logical channels providing the more than one bits. At least one of the logical channels may correspond to one of the following: a DS0 signal, a DS1 signal, a fractional DS1 signal, and a clear-channel DS3 signal.

In general, in another aspect, the disclosure describes an apparatus for generating an HDLC (High-Level Data Link Control) frame. The apparatus includes inputs for a group of bits and a logic network configured to apply an HDLC stuffing operation to the more than one of the bits in parallel.

In general, in another aspect, the disclosure describes an apparatus for processing bits of an HDLC (High-Level Data Link Control) frame. The apparatus includes inputs for receiving bits of the HDLC frame and a logic network configured to apply an HDLC destuffing operation to more than one of the bits in parallel.

Advantages will become apparent in view of the following description, including the figures and the claims.

### BRIEF DESCRIPTION OF THE DRAWINGS

FIG. 1 is a diagram of an HDLC (High-Level Data Link Control) Frame.

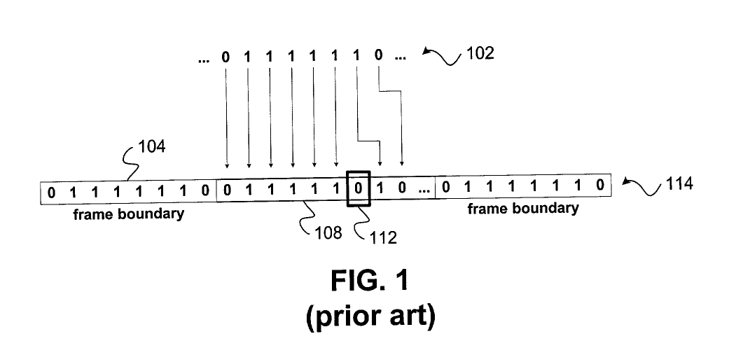

FIG. 2 is a diagram of an HDLC framer.

FIG. 3 is a diagram of an HDLC frame receiver.

FIG. 4 is a schematic of HDLC framer logic.

FIG. 5 is a schematic of HDLC frame receiver logic.

FIG. 6 is a diagram of an HDLC framer system that can process HDLC frames for transmission over different channels.

FIG. 7 is a diagram of an HDLC frame receiver that can process HDLC frames received over different channels.

FIG. 8 is a diagram of a device including an HDLC framer and receiver.

### DETAILED DESCRIPTION

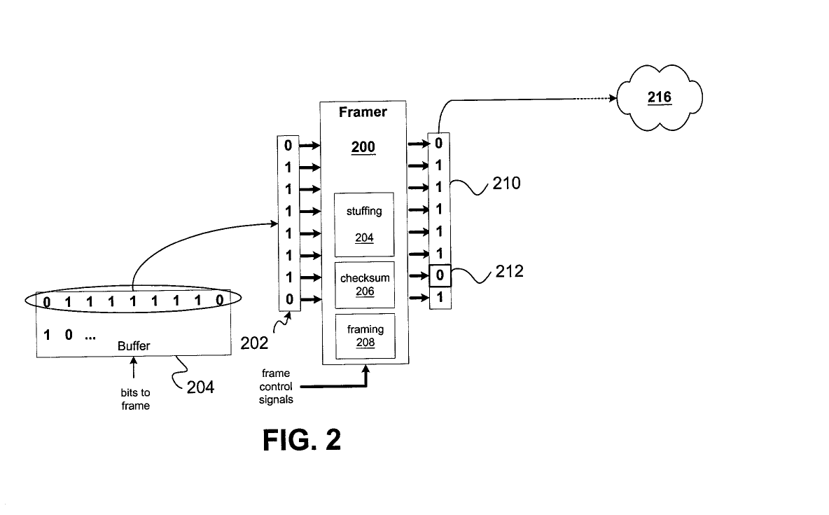

FIG. 2 illustrates an HDLC (High-Level Data Link Control) framer 200 that generates HDLC frames for a stream of bits 204. Instead of serially processing the bits 204, the framer 200 processes bits of the stream 204 in parallel. In other words, the framer 200 operates on a group of bits 202 simultaneously to generate the corresponding HDLC frame bits 210. For example, as shown, the framer 200 processes a group of bits of “01111110” 202 in parallel to generate stuffed HDLC bits that begin “01111101” 212.

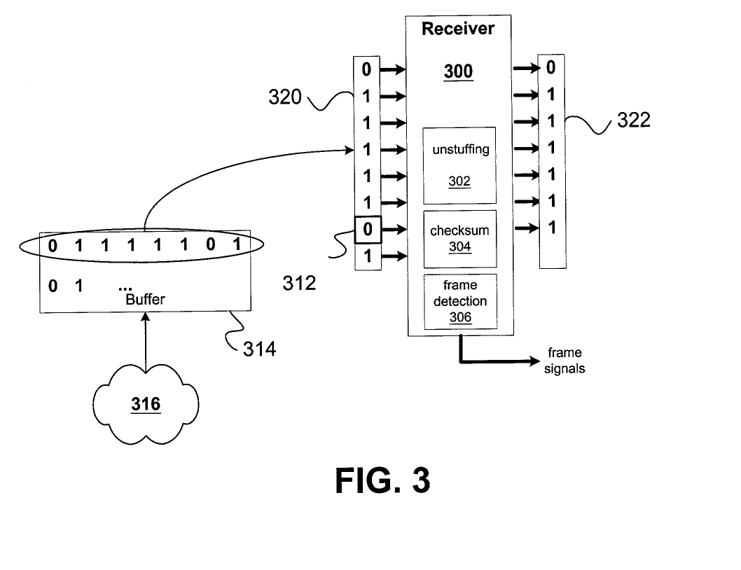

Similarly, FIG. 3 illustrates an HDLC frame receiver 300 that processes bits 320 of received HDLC frames in parallel. For example, as shown, the receiver 300 can generate output bits 322 that correspond to a destuffing of a group 320 of HDLC bits.

The parallel processing illustrated in FIGS. 2 and 3 can enable the framer 200 and receiver 300 to run at slower clock speeds. For instance, instead of using a clock tick to process each bit in turn, the systems can buffer a group of bits to process en masse, for example, in a single clock tick. By reducing the number of ticks needed to process the bits, the framer 200 and receiver 300 can use relatively inexpensive hardware to keep up with high speed network connections.

In greater detail, FIG. 2 illustrates a framer 200 that generates bits 210 of an HDLC frame for subsequent transmission over a network 216. As shown, the bits being framed may accumulate in a buffer 204. The framer 200 can then pull off a group of bits 202 from the buffer 204 for parallel processing. The framer 200 may be configured to simultaneously process 2ⁿ (e.g., 2, 4, 8, 16, 32, . . . ) or some other number of bits.

As shown, the framer 200 performs a variety of tasks involved in generating an HDLC frame such as the computation 206 of a frame checksum (e.g., a 16 or 32 bit CRC (Cyclic Redundancy check) checksum) for inclusion in the frame. The framer 200 also receives control signals, such as start-of-frame, end-of-frame, and abort-frame signals, and generates the appropriate HDLC bit sequences as output.

As described above, the framer 200 also performs stuffing 204. For example, as shown, the sequence “0111110” 202 results in stuffed output that begins “01111101” 212. Bit sequences of interest, however, may not neatly fall within a single group of bits. For example, a sequence of five consecutive “1”s that should prompt stuffing may overlap different bit groups. For instance, a sequence of “01111110” may be spread over a first group of bits, “xxxx0111”, and a second group of bits, “1110xxx”. To stuff this sequence, the framer 200 stores a history of previously processed bits. For example, the history can include data identifying a number of trailing “1”-s in a previous group of bits. For instance, after processing the first group, “xxxx0111”, the framer 200 stores data indicating the group ended with three consecutive “1”s. The framer 200 can, thus, identify the second bit of the second group, “1110xxx”, as the fifth consecutive “1” and stuff a “0” after the second bit to yield “11010xxxx”.

Just as the framer 200 in FIG. 2 operates on groups of bits in parallel to generate an HDLC frame, FIG. 3 depicts a frame receiver 300 that operates on bits 314 of an HDLC frame in parallel. For example, bits 314 of an HDLC frame may be stored in a buffer as they arrive over a network 316 for processing by the receiver 300 in groups 320 of bits.

As shown, the receiver 300 provides destuffing 302, verifies the checksum 304 of an HDLC frame, detects HDLC flag and abort sequences (i.e., sequences of between 7 and 21 consecutive “1”-s), and performs other tasks in handling HDLC frames. Like the framer 200, bit patterns of interest, may not neatly fall within a single group of bits processed by receiver 300. For example, a frame boundary flag of “01111110” may straddle different bit groups (e.g., “xxxx0111” and “1110xxxx”). Similarly, a sequence that should be destuffed may be spread over multiple bit groups. To correctly process bits, the receiver 300, like the frame, can store a history of previously processed bits. For example, the receiver 300 can store a number of consecutive “1”-s ending a previous group of bits. Based on this information, the receiver 300 can correctly process frame flags, unstuff bits, and verify an HDLC frame's checksum.

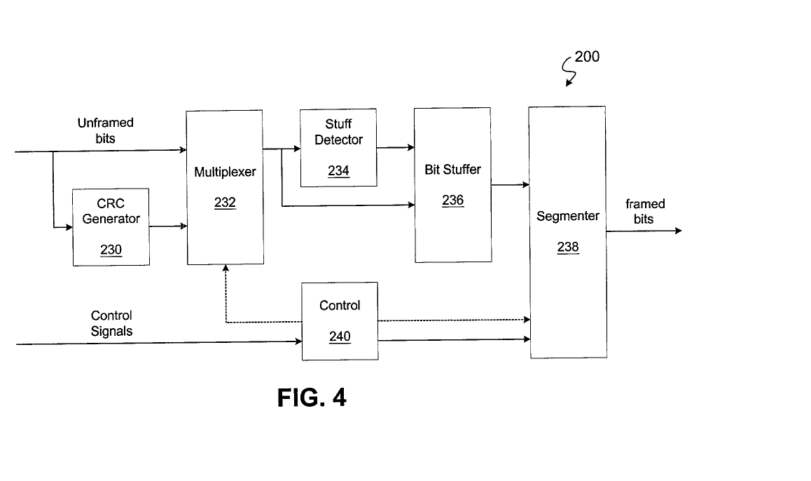

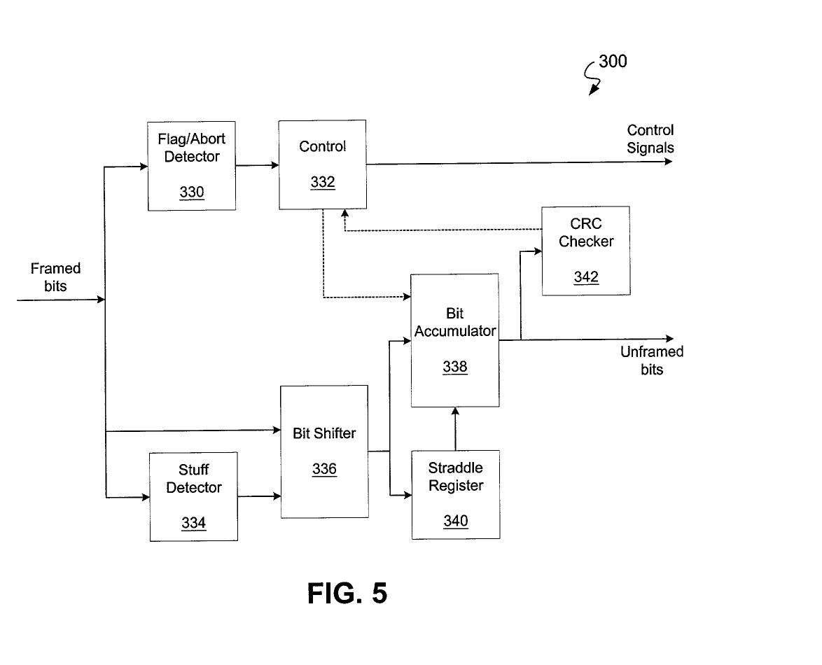

FIGS. 4 and 5 illustrate sample implementations of framer and receiver logic. The logic shown in these figures can be implemented as a network of combinatorial digital logic. Preferably, such logic can be constructed to reduce the number of clock cycles used to process a group of bits in parallel to a single cycle. The logic may be implemented in a variety of ways such as traditional digital logic gates. Alternatively, the logic may be implemented as a FPGA (Field Programmable Gate Array) configured, for example, based on a programmatic description of logic in a language known as Verilog®.

In greater detail, FIG. 4 depicts the logical design of an HDLC framer 200. As shown, a group of unframed bits arrives at a CRC generator 230 that progressively computes a checksum for bits included within an HDLC frame as the bits arrive. Since the framer 200 stuffs both the unframed bits and the CRC checksum, a multiplexer 232, under the control of control logic 240, selects either the unframed bits or the current CRC generator 230 output for stuffing.

As shown, the stuffing logic includes a stuff detector 234 and stuffer 236. The detector 234 searches for stuff sequences (i.e., five consecutive “1”-s). For stuff sequences that overlap different bit groups, the detector 234 stores and accesses the number of trailing “1”-s from the previous bit group(s). Based on this information, the detector 234 generates a code indicating stuff positions in the current group of bits. The bit stuffer 236 inserts stuffing “0”-s based on the code generated by the stuff detector 234 and the multiplexer 232 output.

The stuffer 236 feeds the stuffed bit sequences to a segmenter 238. The number of bits sent to the segmenter 238 may vary based on the number of “0”-s stuffed by the stuffer 236. For example, an unframed eight-bit group (“octet”) of bits of “11111111” can yield a stuffed group of up to ten HDLC bits (e.g., “1011111011”). To adapt to the variable length output of the stuffer 236, the segmenter 238 may be configured to act as a FIFO (First-In-First-Out) queue that buffers bits sent by the bit: stuffer 236 and outputs a more uniform number of bits with each clock. For example, while the segmenter 238 may receive between 8 to 10 bits from the stuffer 236, the segmenter 238 may output framed bits at a rate of 8-bits per clock. Framed bits not: output during one clock cycle are stored and output at the start of the next output cycle.

As shown, the segmenter 238 also receives bit sequences from control logic 240 such as frame flag and abort sequences. These bits may be appended to the current segmenter 238 FIFO for subsequent output. The control logic 240 may generate the flag or abort sequence in response to receiving a control signal (e.g., start-frame, end-frame, or abort).

The control logic 240 may also perform other tasks. For example, potentially, the storage capacity of the segmenter 240 may be filled. If so, the control 240 logic may temporarily stall processing of new groups of unframed bits.

FIG. 5 depicts the logical design of an HDLC frame receiver 300 that processes received framed bits in parallel and outputs unframed bits and frame controls signals. As shown, the receiver 300 includes a flag detector 330 that searches received frame bits for flag and abort sequences. Again, since bits of a flag or abort sequence may be spread over multiple bit groups, the detector 330 stores and accesses data identifying bits of a previous group that may form part of a flag completed in the current group of bits. Upon detection of a flag, the detector 330 causes control logic 332 to output a corresponding control signal.

The control logic 332 also maintains the frame state of the receiver. The state controls how the different components operate. The receiver 300 is, initially, in a no_sync state while awaiting an initial flag. When a flag is detected, the receiver enters the hunt state, and awaits a non-flag group of bits. Such bits causes the receiver to enter the in_frame state. Reception of another flag causes the sequencer to return to the hunt state. Reception of an abort sequence resets the receiver to the no-sync state.

The receiver 300 also includes destuffing logic 334, 336 that operates on received frame bits. More particularly, the receiver 300 includes a stuff detector 334 that searches incoming frame bits for five consecutive “1”-s. After detecting these sequences, the detector 334 generates a code identifying the bit positions of “0”-s to destuff. Again, because a stuff sequence may overlap groups of bits, the detector stores a count of trailing “1”-s of the next bit group.

The received frame bits and the output of the stuff detector 334 are processed by a bit-shifter 336 to destuff the received frame bits. For example, based on frame bits of “01111101”, the bit shifter 336 can output a destuffed set of bits of “0111111”. As illustrated by this example, the bit shifter 336 may output a variable number of bits based on the number of stuffed “0”-s removed from a sequence. For example, for an eight-bit input, the bit shifter may output anywhere from six to eight bits.

A bit accumulator 338 receives and buffers the unstuffed bits from the bit shifter 336. The accumulator 338 can output the unframed bits in n-bit batches. For example, the accumulator 338 can store a count of the number of bits currently buffered and output n-bit batches when n-bits have accumulated. The accumulator 338 can store the remaining bits for subsequent output.

As shown, the bits output by the accumulator 338 are progressively processed by a CRC checker 342. For example, after detection of a frame flag by flag/abort detector 330, if the CRC checker 342 detects a transmission error, control logic 332 can output an appropriate frame control signal.

The receiver 300 is logically constructed to “strip out” frame flag bits before they reach the CRC checker 342 and the output stream. Since frame flags may straddle different groups of bits, the beginning of the boundary flag may reach the accumulator 338 before the flag is recognized. Thus, the logic is constructed such that the accumulator 338 “backs out” the flag bits already stored in the accumulator 338. To perform this task, the accumulator 338 can adjust its count of stored bits. For example, after receiving “xxxx0111”, the accumulator 338 would have a count of 8 stored bits. After receiving “1110xxxx” and the flag/abort detector 330 detects the straddling flag, the control logic 332 can instruct the bit accumulator 338 to decrement its count in an amount based on the position of the flag in the previous group of bits (e.g., 4).

A straddling flag also poses another problem in that the bits following the end of the flag may belong to a different HDLC frame. For example, the “x” bits in “1110xxxx” may correspond to the first bits of a new frame. To address this scenario, bits following a flag are temporarily stored in a straddle register 340. After the bits of the previous frame are output by the accumulator 338, the accumulator 338 receives the bits stored by the straddle register.

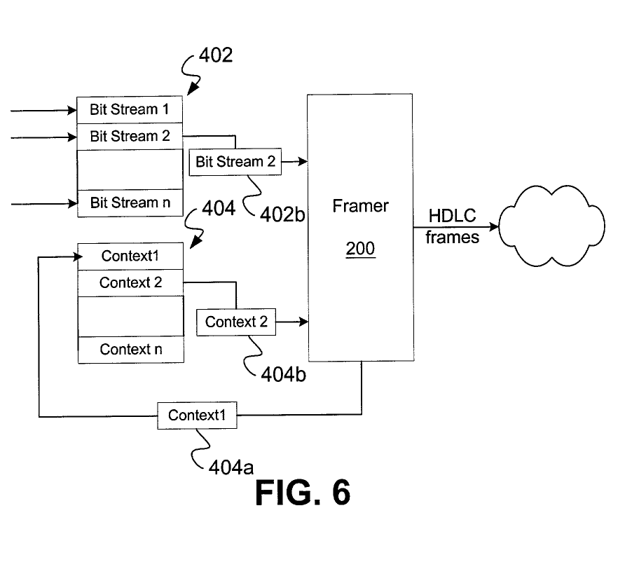

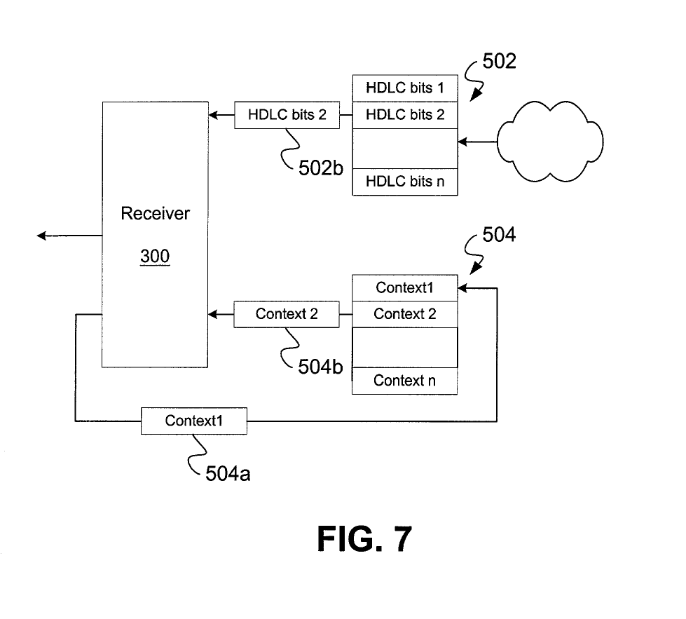

FIGS. 6 and 7 illustrate framer 200 and receiver 300 systems that can process multiple HDLC frames carried by different channels. As shown, both systems feature a context memory 404, 504 that stores the current state of HDLC processing for a given channel. For example, the context of a channel may include a number of trailing “1”-s in a preceding group of bits. By rapidly switching the context supplied to the framer or receiver, the same logic can process many different channels. Since, the framer and receiver process chunks of channel data bits in parallel, the framer/receiver can keep apace the continual accumulation of bits of the different channels. By using the same logic to serve different channels, this scheme can reduce overall system cost.

A logical channel may correspond to a member of the DSx hierarchy. For example, a channel may correspond to a DS0 signal, a DS1 signal or fractional DS1 signal (e.g., up to 24 DS0 signals), or a clear-channel DS3 signal. Or, more generally, the logical channel may correspond to a channel within a time division multiplex scheme.

In greater detail, FIG. 6 illustrates an HDLC framer system that processes the bits of different logical channels 402. Bit groups of the different channels are processed in turn. For example, the framer 200 may process an octet for bit stream 1, then next process an octet 402b for bit stream 2.

As shown in FIG. 6, the system also includes a context memory 404 that stores the context or processing state of the framer 200 for the bits of a particular channel. For the sample implementation illustrated in FIG. 4, the context can include the CRC bits thus far computed for a frame, the number of trailing “1”-s in the previous group of bits, the bits buffered by the segmenter, and so forth.

The bit streams 402 and contexts 404 are coordinated such that the framer 200 simultaneously receives the bits of a channel queue 402 and the corresponding context 404. For example, when processing Bit Stream 1, the framer 200 receives Context 1. Similarly, when processing Bit Stream 2, the framer 200 receives Context 2. As shown, the current context of a channel is saved while the context of a different channel is swapped in. For example, after processing bits from bit stream 1, the framer 200 saves updated Context 1 to the memory 404 and receives Context 2.

To perform context swapping, the memory 404 can feature dual ports (e.g., a read and write port) that permit simultaneous reading and writing of different memory addresses. Such a memory 404 may require time to retrieve a context. Thus, context retrieval should be initiated prior to the application of the channel bits corresponding to the context.

FIG. 7 shows a receiver 300 system that processes the bits 502 of HDLC frames received over different logical channels. As shown, a context memory 504 stores the processing context for the channels. The context for a channel can include the computed CRC bits for the current frame, the number of trailing “1”-s in a previous group of bits, the bits of the straddle register or accumulator, the processing state (e.g., in frame, out of frame, or hunt), and so forth.

Like the framer system shown in FIG. 6, the receiver 200 receives HDLC bits 502b of a channel and the corresponding context 504b. After processing a group of bits, the current context is swapped back into memory and replaced by a context of the next channel to be processed.

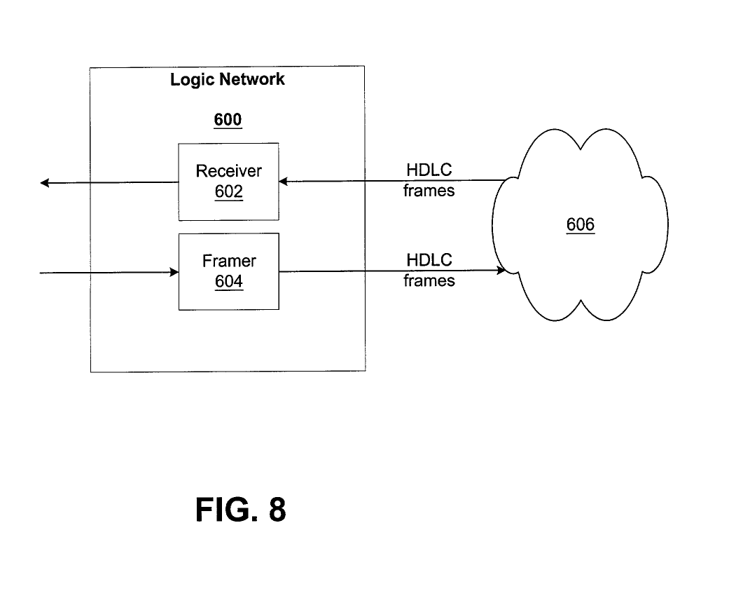

While described above as individually provided components, a framer and receiver may be provided together. For example, FIG. 8 illustrates a system that includes both a receiver 602 and framer 604. While shown as only having a single receiver and framer, other systems may include multiple receivers and framers.

The techniques described herein are not limited to a particular configuration. Other embodiments are within the scope of the following claims.

What is claimed is:

1. A method of generating an HDLC (High-Level Data Link Control) frame, the method comprising:
receiving a group of bits; and
determining HDLC frame bits by applying an HDLC stuffing operation to more than one of the bits in parallel.

2. The method of claim 1, wherein the more than one bits comprises 2ⁿ bits, where n>0.

3. The method of claim 1, wherein the applying the HDLC stuffing operation comprises applying the operation in a single clock cycle.

4. The method of claim 1, wherein the applying the HDLC stuffing operation comprises applying combinatorial logic on the more than one bits.

5. The method of claim 4, wherein the combinatorial logic comprises logic implemented on a FPGA (Field Programmable Gate Array).

6. The method of claim 1, wherein applying the HDLC stuffing operation comprises identifying a number of trailing “1”-s in a previous group of bits.

7. The method of claim 1, further comprising receiving HDLC control signals and outputting corresponding HDLC bit sequences.

8. The method of claim 7, wherein the control signals comprise start-of-frame, end-of-frame, and abort.

9. The method of claim 1, further comprising determining an HDLC checksum.

10. The method of claim 1, further comprising:
receiving bits from different logical channels;
storing a context for the different logical channels, the context including information used in the HDLC stuffing operation; and
accessing the context for a one of the logical channels providing the more than one bits.

11. The method of claim 10, wherein at least one of the logical channels corresponds to one of the following: a DS0 signal, a DS1 signal, a fractional DS1 signal, and a clear-channel DS3 signal.

12. A method of processing bits of an HDLC (High-Level Data Link Control) frame, the method comprising:
receiving bits of the HDLC frame; and
applying an HDLC destuffing operation to more than one of the bits in parallel.

13. The method of claim 12, wherein the more than one bits comprises 2ⁿ bits, where n>0.

14. The method of claim 12, wherein the applying the HDLC destuffing operation comprises applying the operation in a single clock cycle.

15. The method of claim 12, wherein the applying the HDLC destuffing operation comprises applying combinatorial logic to the more than one bits.

16. The method of claim 15, wherein the combinatorial logic comprises logic implemented on a FPGA (Field Programmable Gate Array).

17. The method of claim 12, wherein applying the HDLC destuffing operation comprises identifying a number of trailing “1”-s in a previous group of bits.

18. The method of claim 12, further comprising detecting HDLC flag and abort sequences.

19. The method of claim 12, further comprising processing the more than one bits in parallel to verify an HDLC checksum.

20. The method of claim 12, further comprising:
receiving bits from different logical channels;
storing a context for the different logical channels, the context including information used in applying the HDLC destuffing operation; and
accessing a context for a one of the logical channels providing the more than one bits.

21. The method of claim 20, wherein at least one of the logical channels corresponds to one of the following: a DS0 signal, a DS1 signal, a fractional DS1 signal, and a clear-channel DS3 signal.

22. An apparatus for generating an HDLC (High-Level Data Link Control) frame, the apparatus comprising:
inputs for a group of bits; and
a logic network configured to apply an HDLC stuffing operation to the more than one of the bits in parallel.

23. The apparatus of claim 22, wherein the more than one bits comprise 2ⁿ bits, where n>0.

24. The apparatus of claim 22, wherein the applying the HDLC stuffing operation comprises applying the operation in a single clock cycle.

25. The apparatus of claim 22, wherein the logic comprises combinatorial logic.

26. The apparatus of claim 25, wherein the combinatorial logic comprises a FPGA (Field Programmable Gate Array).

27. The apparatus of claim 22, wherein the logic for applying the HDLC stuffing operation comprises logic for identifying a number of trailing “1”-s in a previous group of bits.

28. The apparatus of claim 22, further comprising at least one input for receiving HDLC control signals and logic for outputting corresponding HDLC control flag and abort sequences.

29. The apparatus of claim 28, wherein the control signals comprise start-of-frame, end-of-frame, and abort.

30. The apparatus of claim 22, further comprising logic for processing the more than one bits in parallel to determine an HDLC checksum.

31. The apparatus of claim 22, further comprising:
storage of contexts for the different logical channels, a context including information used in applying the HDLC stuffing operation; and
logic constructed to access the context for a one of the logical channels providing the more than one bits.

32. The apparatus of claim 31, wherein at least one of the logical channels corresponds to one of the following: a DS0 signal, a DS1 signal, a fractional DS1 signal, and a clear-channel DS3 signal.

33. Apparatus for processing bits of an HDLC (High-Level Data Link Control) frame, comprising:
inputs for receiving bits of the HDLC frame; and
a logic network configured to apply an HDLC destuffing operation to more than one of the bits in parallel.

34. The apparatus of claim 33, wherein the more than one bits comprises 2ⁿ bits, where n>0.

35. The apparatus of claim 33, wherein the logic network constructed to apply the HDLC destuffing operation comprises a logic network constructed to apply the operation in a single clock cycle.

36. The apparatus of claim 33, wherein the logic network constructed to apply the HDLC destuffing operation comprises a logic network constructed to apply combinatorial logic on the more than one bits.

37. The apparatus of claim 36, wherein the combinatorial logic comprises logic implemented on a FPGA (Field Programmable Gate Array).

38. The apparatus of claim 33, wherein the logic network constructed to apply the HDLC destuffing operation comprises a logic network constructed to identify a number of trailing “1”-s in a previous group of bits.

39. The apparatus of claim 33, further comprising logic constructed to detect HDLC flag and abort sequences.

40. The apparatus of claim 33, further comprising logic constructed to process the more than two bits in parallel to verify an HDLC checksum.

41. The apparatus of claim 33, further comprising logic constructed to:
store bits from different logical channels;
store a context for the different logical channels, the context including information used in applying the HDLC destuffing operation; and
access a context for a one of the logical channels of the more than on bits currently being processed.

42. The apparatus of claim 41, wherein at least one of the logical channels corresponds to one of the following: a DS0 signal, a DS1 signal, a fractional DS1 signal, and a clear-channel DS3 signal.
